(19) United States
(12) Patent Application Publication
(10) Pub. No.: US 2017/0198871 A1
(43) Pub. Date: Jul. 13, 2017

(54) Reconfigurable Lighting System

(71) Applicant: John Keenan, Mequon, WI (US)

(72) Inventor: John Keenan, Mequon, WI (US)

(21) Appl. No.: 15/403,305

(22) Filed: Jan. 11, 2017

Related U.S. Application Data
(60) Provisional application No. 62/277,071, filed on Jan. 11, 2016.

(51) Int. Cl. F21S 8/00; A47F 5/08; F21V 21/088; A47B 95/00; F21V 21/14; F21V 23/00

(52) U.S. Cl. CPC F21S 8/036; F21V 21/14; F21V 23/001; F21V 21/088; A47B 95/008; A47F 5/0846; F21V 23/06

(57) ABSTRACT

A lighting system is provided that is formed of a number of separate lighting elements that each include an attachment member or bracket secured to the lighting element. Each element is readily attachable to a wall storage system to secure the lighting element where desired such that the lighting element can illuminate the desired area of the storage system. The individual lighting elements are connected to one another by interconnecting members that can be selectively engaged between the lighting elements placed in the desired configuration, and rotatable clips of the brackets can be utilized to orient the lighting elements in the desired manner on the wall storage system.

### CROSS-REFERENCE TO RELATED APPLICATIONS

The present application claims priority from U.S. Provisional Patent Application Ser. No. 62/277,071, filed on Jan. 11, 2016, the entirety of which is expressly incorporated by reference herein for all purposes.

### FIELD OF THE INVENTION

The present invention relates generally to lighting systems, and more specifically to a lighting system that is selectively attachable in a re-configurable manner on a wall storage system.

### BACKGROUND OF THE INVENTION

Many different types of wall structures/storage systems exist that enable individuals to mount different items on the wall structure. These structures allow the individual to store various items is a highly efficient manner within a relatively small space, such as in a garage or other similar location. On example of wall structure or storage system the is used for this purpose is disclosed in U.S. Pat. No. 5,941,026 entitled Slatwall Display System, the entirety of which is expressly incorporated herein by reference for all purposes.

However, prior art storage system or wall structures do not readily enable the individual to see what is being stored using the system if the lighting in the particular area in which the system is employed is insufficient. While the individual can hang certain lighting elements on the storage system hooks or other hanging elements in these prior art systems, these lights can be easily knocked off of the hooks and/or do not readily illuminate the entire area covered by the storage system.

Thus, it is desirable to develop a lighting system for a storage system that overcomes these issues with prior art storage systems.

### SUMMARY OF THE INVENTION

Briefly described, according to an exemplary embodiment of the invention, a lighting system is formed of a number of separate lighting elements that each include an attachment member or bracket secured to the lighting element. Each element is readily attachable to a wall storage system to secure the lighting element where desired such that the lighting element can illuminate the desired area of the storage system.

According to another exemplary embodiment of the invention, the lighting elements can be selectively positioned on the storage system and can be selectively interconnected with one another.

Numerous other aspects, features, and advantages of the invention will be made apparent from the following detailed description together with the drawings figures.

### BRIEF DESCRIPTION OF THE DRAWINGS

The drawings illustrate the best mode currently contemplated of practicing the present invention.

In the drawings:

FIG. 1 is a front perspective view of a prior art storage system;

FIG. 2 is a front perspective view one exemplary embodiment of a lighting system constructed according to the present disclosure attached to the storage system of FIG. 1;

FIG. 3 is a front elevation view of one exemplary embodiment of a lighting element of the lighting system of FIG. 2;

FIG. 4 is a front elevation view of one exemplary embodiment of a pair of interconnected lighting elements of the lighting system of FIG. 2;

FIG. 5 is an isometric view of one exemplary embodiment of a power cord interconnecting a pair of lighting elements of the lighting system of FIG. 2;

FIG. 6 is an isometric view of one exemplary embodiment of a direct interconnecting member used to join a pair of lighting elements of the lighting system of FIG. 2;

FIG. 6A is a side plan view of the direct interconnecting member of FIG. 6 joining a pair of lighting elements of the lighting system of FIG. 2;

FIG. 7 is an isometric view of another exemplary embodiment of a lighting system constructed according to the present disclosure attached to the storage system of FIG. 1;

FIG. 8 is a perspective view of another exemplary embodiment of a lighting element of the lighting system of FIG. 2;

FIG. 9 is a perspective view of another exemplary embodiment of an attachment bracket for the lighting system of FIG. 2;

FIG. 10 is a perspective view of the power cord and direct interconnecting member of the lighting system of FIG. 2; and

FIG. 11 is a perspective view of the attachment brackets of FIG. 9.

### DETAILED DESCRIPTION OF THE INVENTION

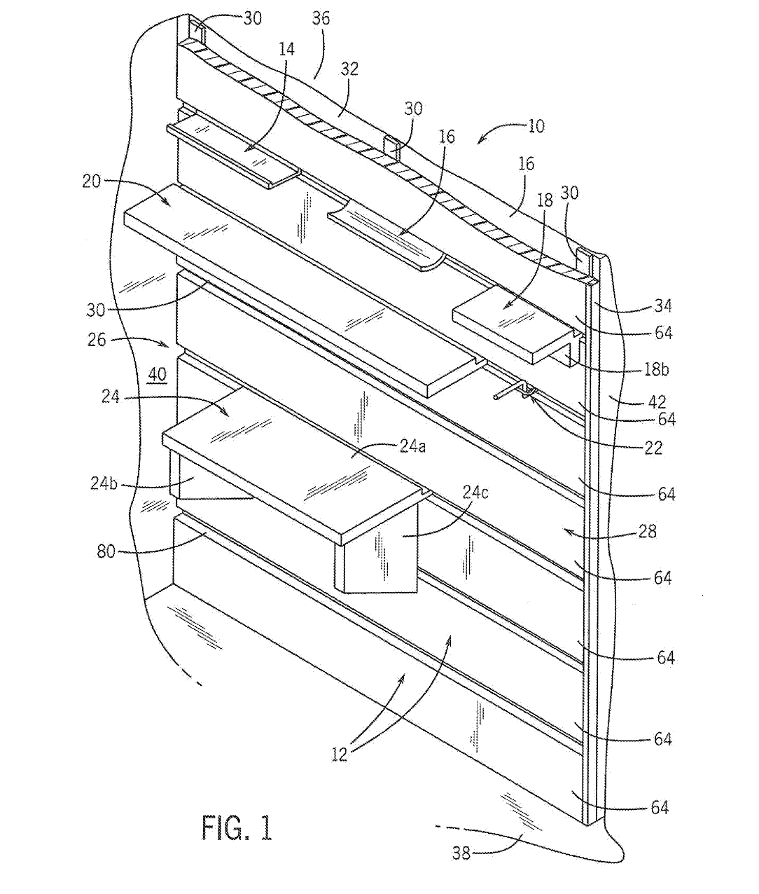

Referring now in detail to the drawing figures, wherein like reference numerals represent like parts throughout the several views, one exemplary embodiment of a prior art wall storage system is found in U.S. Pat. No. 5,941,026 entitled Slatwall Display System, which is expressly incorporated herein in its entirety by reference for all purposes and is illustrated generally at 10 in FIG. 1. The slatwall display system constructed in accordance with the principles of the invention for supporting and displaying various types of article holders 14, 16, 18, 20, 22, and 24 from a front side thereof. The system 10 is comprised of a series of horizontally disposed, generally rectangular slat panels 12 juxtaposed and interconnected together, one atop the other, at slatwall panel joints 26 to form a slat panel assembly 28. The slat panel assembly 28 is supported on a set of vertically extending mounting members 30 rigidly anchored to a vertical wall 32. Both slat panels 12 and mounting members 30 are substantially rigid elements and are can be formed of any suitable material, such as extruded polyvinylchloride (PVC). An elongated, U-shaped finished cap 34 is provided to conceal the exposed side edges of the slat panel assembly 28. In the preferred embodiment of FIG. 1, it can be seen that the slat panel assembly 28 extends lengthwise from a ceiling 36 which is perpendicular to the wall 32 downwardly and completely to a floor 38. The slat panel assembly 28 also extends widthwise from one adjoining vertical wall 40 to another adjoining vertical wall 42. It should be appreciated from the outset of this description that the slat panel assembly 28 could also be mounted on a free-standing vertical wall which could carry the slat panels on one or both sides thereof as desired by the user. The article holders 14-24 are engaged within recesses 80 formed in the panel 12 that frictionally engage the portions of the holders 14-24 inserted within the recesses 80.

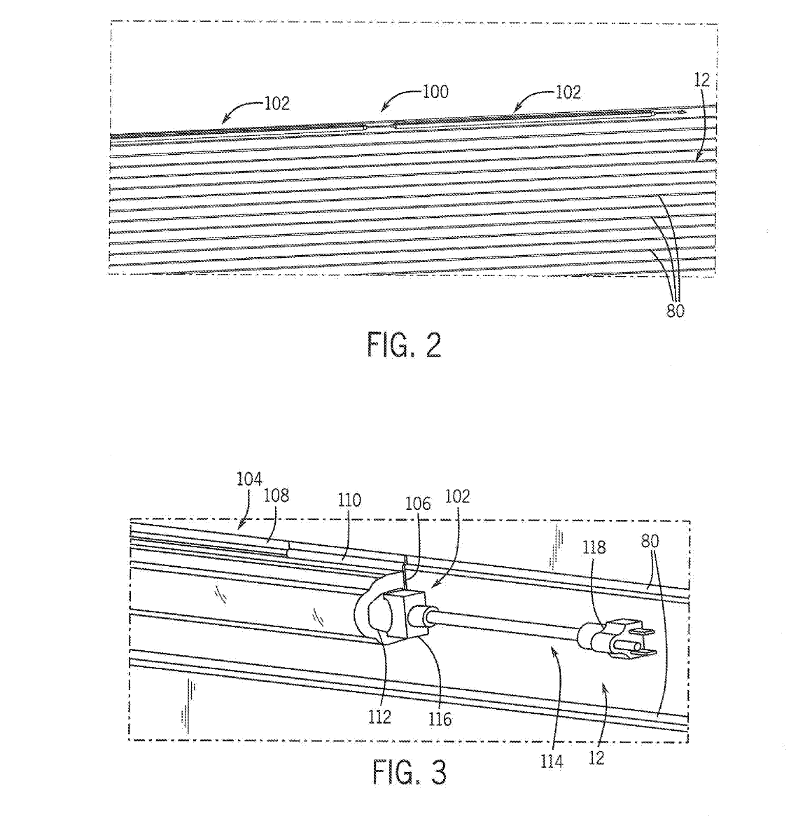

Referring now to FIGS. 2-7, in one exemplary embodiment a lighting system 100 is attached to the storage system 10. The lighting system 100 includes a number of lighting elements 102, which can be any suitable light source, such as a fluorescent or light-emitting diode (LED) light source, among others, that are secured to the storage system 10 using brackets 104. The brackets 104 are secured to the lighting elements 102, either as a direct part of the lighting element 102 or as a separate component affixed to the lighting element 102, and include a first end 106 secured to the lighting element 102 and a second end 108 spaced from and joined to the first end 106, such as by a living hinge 110 or other suitable structure. The second end 108 is insertable within the recesses 80 of the panel 12 in order to hold the bracket 104 and the lighting element 102 on the panel 12. The second end 108 is also slidable with regard to the recess 80 in order to allow the position of the lighting element 102 to be adjusted within the recess 80 as desired. The engagement of the bracket 104 with the recess 80 can be easily engaged and disengaged in order to position the lighting element 102 where desired on the panel 12.

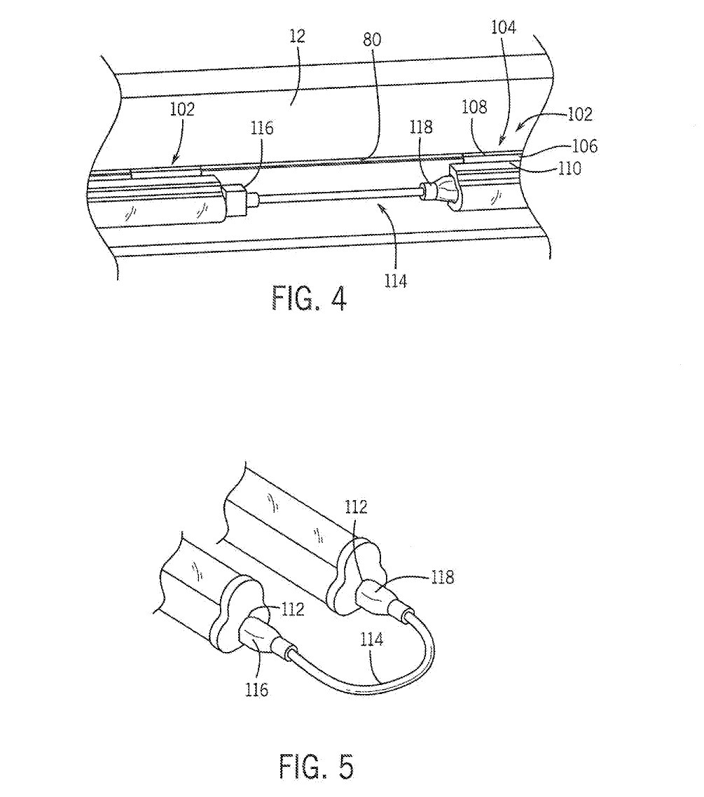

Looking now at FIGS. 3-6A, in order to electrically interconnect multiple lighting elements 102, e.g., in series, to a power source, such as a wall outlet (not shown) and/or with one another, each lighting element 102 includes a socket 112,113 at each end. The sockets 112,113 are configured to be complementary to one another, such that the socket 112 is a male socket, while socket 113 is a female socket. As shown in the exemplary embodiment illustrated in FIG. 3, the socket 112 is able to receive a power cord 114 having a lighting element female connector 116 at one end and a male plug 118 at the opposite end, which can be engaged with a suitable wall outlet (not shown). Alternatively, as shown in the illustrated exemplary embodiment of FIG. 4, the plug 118 can be engaged within a complementary socket 113 disposed on an adjacent lighting element 102 in order to engage the pair of lighting elements 102 in series with one another. The length of the cord 114 can be selected as desired in order to enable the lighting elements 102 to be positioned in various configurations (FIG. 5), such as in or not in alignment with one another, and cords 114 of various lengths can also be used to connect the lighting elements 102 to the power source and to one another in the desired configurations.

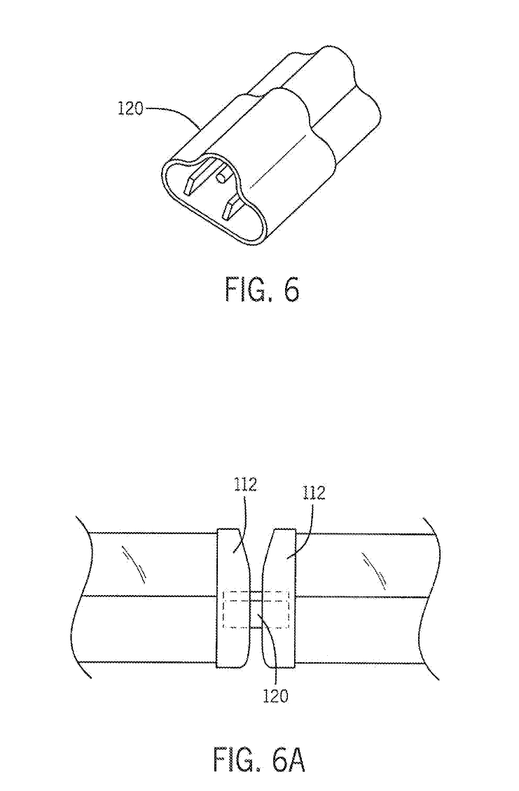

Alternatively, or in conjunction with one or more cords 114, adjacent lighting elements 102 can be interconnected using a rigid direct interconnecting member 120, as shown in FIG. 6 and 6A. This member 120 is formed with opposed ends being complementary to the sockets 112,113 in order to be engaged between the sockets 112,113 of immediately adjacent lighting elements 102 and positions the lighting elements 102 in direct alignment with and abutting one another when attached to the panel 12.

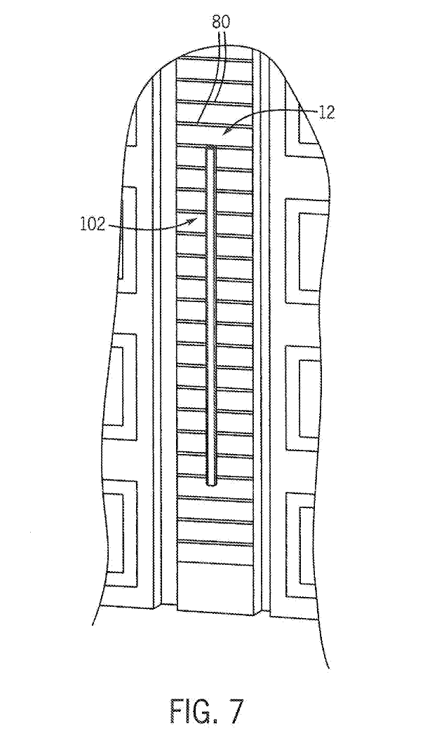

In still another exemplary embodiment, the brackets 104 can be configured and/or oriented on the lighting elements 102 to support the lighting elements 102 on the panel 12 in a vertical orientation, as shown in FIG. 7, as opposed to the horizontal orientation of FIGS. 2-6.

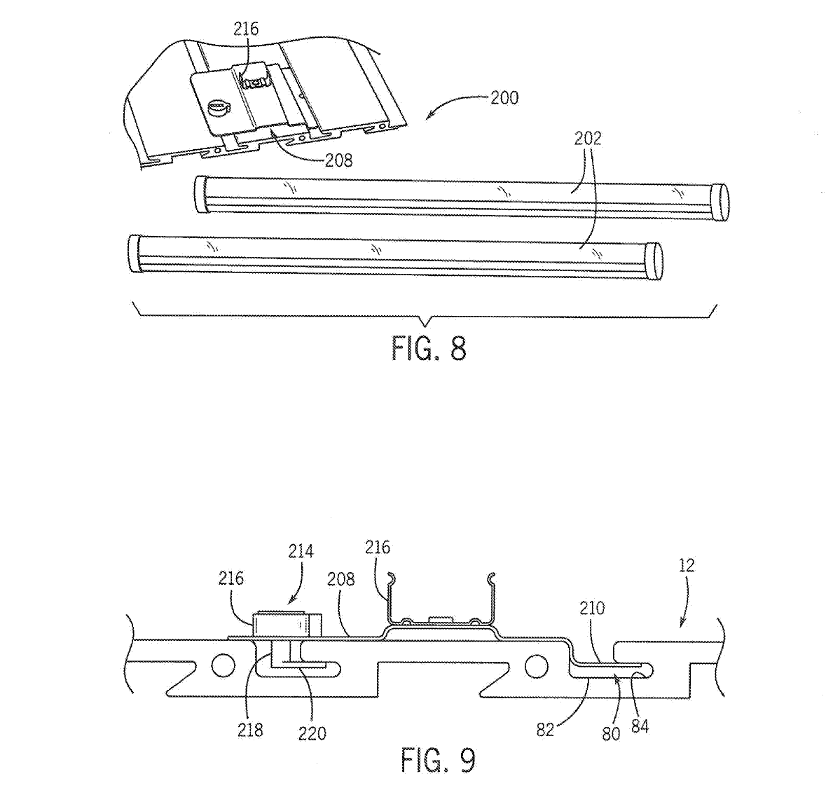

Referring now to FIGS. 8-11, another exemplary embodiment of the lighting system 200 is illustrated. In this embodiment, the lighting elements 202 of the system 200 are releasably engaged within spring clips 206 that are in turn secured, optionally rotatably, to mounting brackets 208 configured to be engaged within the recesses 80 of the panel 12.

The mounting brackets 208 include a tab 210 at one end that is engageable within on recess 80 to support the bracket 208 on the panel 12. Opposite the tab 210, the bracket 208 includes a locking member 214. The locking member 214 includes a head 216, a shaft 218 connected to the head 216 and extending through the bracket 208 and a flange 220 disposed on the shaft 218 opposite the head 216. When the locking member 212 is in the unlocked position, the flange 220 is aligned with the wide portion 82 of the recess 80 and can be inserted into the recess 80. Within the recess 80, the head 216 can be rotated, consequently rotating the shaft 218 and the flange 220, moving the flange 218 into the narrow portion 84 of the recess 80, thereby engaging the flange 220 within the narrow portion 84 and preventing the locking member 214 from being removed from the recess 80. This process can be reversed when it is desired to disengage the locking member 214 and remove the bracket 208 from the panel 12.

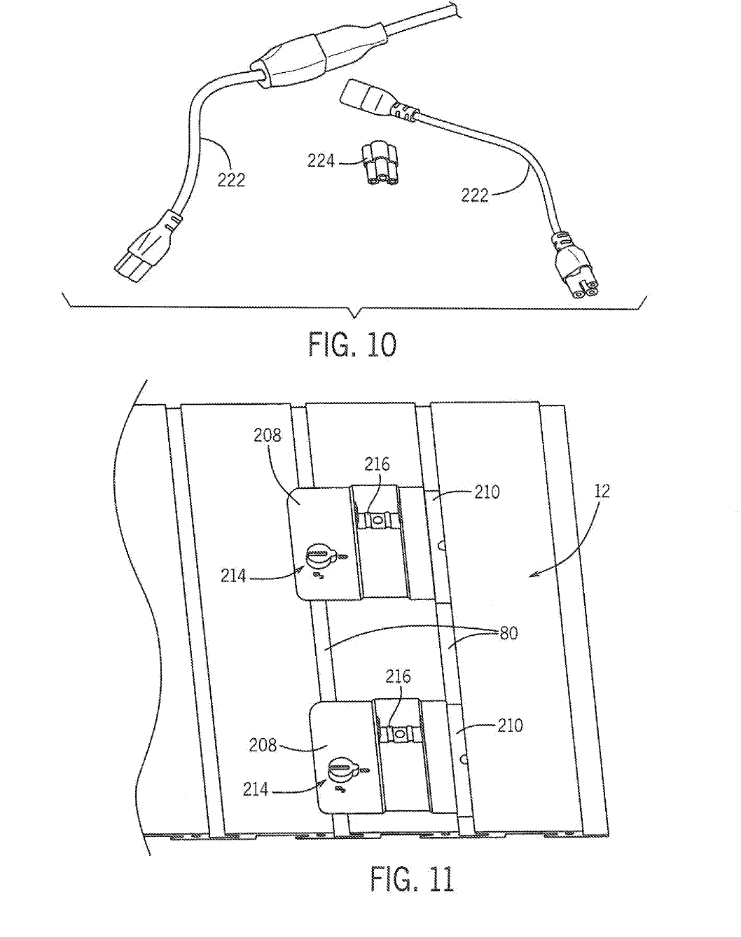

On the bracket 208, the clips 206 hold the lighting element 202 inserted into the clip 206. The clips 206 frictionally hold the lighting element within opposed arms 226 of the clip 206 to allow the lighting elements 202 to be readily inserted and removed from the brackets 206 as desired. In addition, the clips 206 can be rotated relative to the bracket 208 in order to position the lighting element 202 at any desired angle on the panel 12 using a single bracket 208 with one or more clips 206 positioned thereon, or between multiple brackets 208 with one or more clips 206 thereon. Further, similarly to the prior embodiments in FIGS. 3-7, the lighting elements 202 can be interconnected with one another and with the power source (not shown) using a power transmission element, such as the cords 222 and/or direct interconnecting members 224 shown in FIG. 10.

Various other embodiments of the invention are contemplated as being within the scope of the filed claims particularly pointing out and distinctly claiming the subject matter regarded as the invention.

1. A reconfigurable lighting system comprising:
a) a bracket adapted to be releasably secured to a wall storage system; and
b) at least one lighting element secured to the bracket.

2. The lighting system of claim 1 further comprising at least two lighting elements interconnected with one another.

3. The lighting system of claim 2 wherein the at least two lighting elements are interconnected by a power transmission element.

4. The lighting system of claim 3 wherein the power transmission element is a cord.

5. The lighting system of claim 4 wherein the cord is configured to connect one lighting element to another lighting element or to a power source.

6. The lighting system of claim 3 wherein the power transmission element is a direct interconnecting member.

7. The lighting system of claim 1 further comprising a clip secured to the bracket and engaged with the at least one lighting element.

8. The lighting system of claim 7 wherein the clip is a spring clip.

9. The lighting system of claim 7 wherein the clip is rotatably mounted to the bracket.

10. The lighting system of claim 1 wherein the bracket is integrally formed with the at least one lighting element.

11. The lighting system of claim 1 wherein the bracket includes a locking member adapted to engage and lock the bracket to the wall storage system.

12. A lighted wall storage system comprising:
at least one mounting member having a projecting ear formed with an upwardly projecting surface;
b) a multiplicity of slat panels interconnected together, one on top of another at spaced slatwall panel joints to define a slat panel assembly, each of the slat panels having a plurality of forward wall portions, a plurality of rearward wall portions spaced rearwardly of the forward wall portions, and a plurality of central wall portions joining the forward wall and rearward wall portions, the rearward wall portions being separated from each other by projecting ear recesses formed between the forward wall and rearward wall portions, the projecting ear recesses including a series of spaced, inverted, generally V-shaped notches receiving the upwardly projecting surface of the projecting ear to retain the slat panels on the mounting member; and
c) a reconfigurable lighting system comprising:
i) a bracket adapted to be releasably secured to a slat panel; and
ii) at least one lighting element secured to the bracket.

13. The lighting system of claim 12 further comprising at least two lighting elements interconnected with one another.

14. The lighting system of claim 13 wherein the at least two lighting elements are interconnected by a power transmission element.

15. The lighting system of claim 13 further comprising a clip secured to the bracket and engaged with the at least one lighting element.

16. The lighting system of claim 15 wherein the clip is rotatably mounted to the bracket.

17. A method of securing a lighting system to a wall storage system, the method comprising the steps of:
a) providing a lighting system including a number of brackets releasably securable to a wall storage system and a number of lighting elements securable to the brackets;
b) engaging the brackets with the wall storage system; and
c) engaging the number of lighting element with the brackets.

18. The method of claim 17 wherein the brackets include clips rotatably engaged with the brackets, and wherein the step of engaging the number of lighting elements with the brackets comprises the steps of:
a) orienting the clips with respect to the brackets; and
b) engaging the number of lighting elements with the clips.

19. The method of claim 17 wherein the step of engaging the number of lighting elements with the brackets further comprises the step of electrically interconnecting the number of lighting elements with one another.

20. The method of claim 19 wherein the step of electrically interconnecting the number of lighting elements comprises engaging interconnecting members between adjacent lighting elements.
